(19) United States
(12) Patent Application Publication
(10) Pub. No.: US 2018/0194426 A1
(43) Pub. Date: Jul. 12, 2018

(54) BiKE

(71) Applicant: Chung Chi Chiang, Taipei (TW)

(72) Inventor: Chung Chi Chiang, Taipei (TW)

(21) Appl. No.: 15/399,835

(22) Filed: Jan. 6, 2017

(51) Int. Cl. B62K 15/00; B62K 3/02; B62K 17/00; B62M 6/90; B62M 3/08; B62M 9/02

(52) U.S. Cl. CPC B62K 15/006; B62K 3/02; B62K 17/00; B62K 2015/005; B62M 3/08; B62M 9/02; B62M 6/90

(57) ABSTRACT

An approach is provided for a foldable bike which comprises a front fork, a top tube, a down tube, a pivot hinge and the pair of auxiliary wheels. The pivot hinge is connected to the first end of the front fork, a second end of the top tube and the first end of the down tube. The first end of the top tube is pivotally connected to the pivot hinge. The first end of the top tube is pivotally connected to the pivot hinge. The auxiliary wheels mounted on the two respect sides of the rear wheel that are extended backwardly from the center of the rear wheel. The pivot hinge allows the front fork and the top tube to be folded toward the down tube. The auxiliary wheels against the ground when the the bike is folded, which is capable of standing and being pulled by a person.

### FIELD OF THE INVENTION

Embodiments of the invention relate to a bike, and more particularly to a foldable bike that is capable of standing and being pulled after folded.

### BACKGROUND

Recently, foldable bikes or foldable electrical bikes have became more popular, which are designed to be foldable that rider can easily carry out or house in the corner. There are more people that willing buy and ride bikes to work or to shopping. Some cities' mass transportation systems such bus, MRT and train which allow people to take their own bikes, regardless is foldable or non-foldable, on the car.

However, the conventional bike can not stand on its own; the owner of the bike needs to hold the bike during the trip on the car or against it to the wall. Moreover, due to the volume of the bike, the person sometimes needs to lift the bike up in the mass transportation system, and thus may not be easy for children or women.

Therefore, there is a need for an approach to provide a foldable bike that is not only foldable to occupy smaller volume, but also can stand and being pulled after folded.

### Some Exemplary Embodiments

These and other needs are addressed by the invention, wherein an approach is provided a foldable bike that is capable of standing and being pulled after folded.

According to one aspect of an embodiment of the invention, a front fork, a top tube, a down tube, a pivot hinge, a seat and a supporter. The front fork has a first end and a second end. The first end of the front fork is connected to a handle, and the second end of the front fork is coupled to a front wheel. The down tube has a first end and a second end. The second end of the down tube is coupled to a rear wheel. The pivot hinge is connected to the first end of the front fork, a second end of the top tube and the first end of the down tube. The first end of the top tube is pivotally connected to the pivot hinge. The seat is mounted on a second end of the top tube. The supporter is connected between the top tube and the down tube respectively.

The pivot hinge allows the front fork and the top tube to be folded toward the down tube. The auxiliary wheels against the ground when the bike is folded, which is capable of standing and being pulled by a person.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is an exemplary diagram illustrating a foldable bike in accordance with an embodiment of the present invention;

FIG. 2 is an exemplary diagram illustrating the movement of the supporter in accordance with an embodiment of the present invention;

FIG. 3 is an exemplary diagram illustrating the movement of the front fork moving toward the down tube in accordance with an embodiment of the present invention;

FIGS. 4 and 5 are exemplary diagrams illustrating the engagement of the front fork and the wheel folded toward the down tube;

FIG. 6 is an partially exemplary diagram of illustrating the handle bar in accordance with an embodiment of the present invention; and

FIG. 7 is an exemplary diagram of illustrating a foldable bike in accordance with an embodiment of the present invention.

### DESCRIPTION OF THE PREFERRED EMBODIMENT

A foldable bike is disclosed. In the following description, for purposes of explanation, numerous specific details are set forth in order to provide a thorough understanding of the embodiment of the invention. It is apparent, however, to one skilled in the art that the present invention may be practiced without these specific details or with an equivalent arrangement.

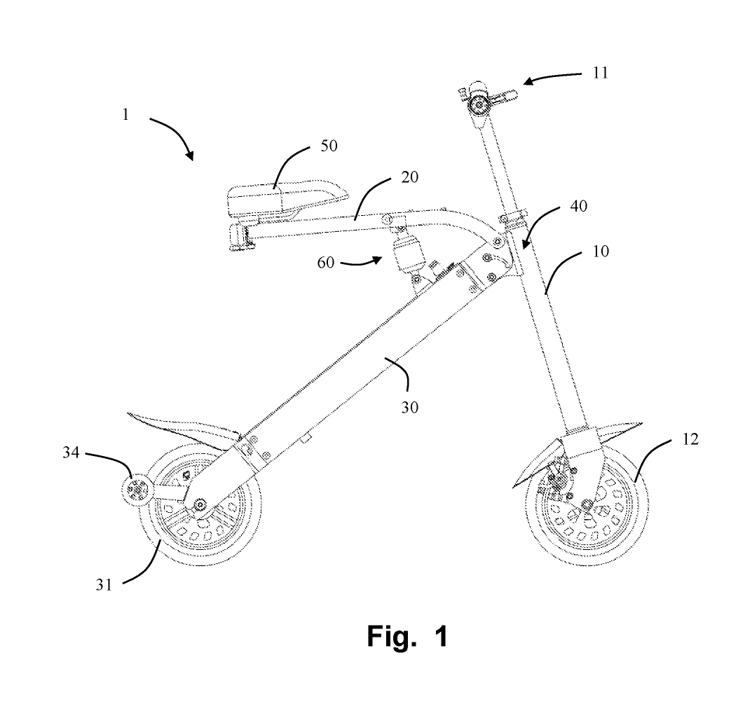

With reference to FIG. 1, FIG. 1 is an exemplary diagram illustrating a foldable bike in accordance with an embodiment of the present invention. In this embodiment, a bike comprises a front fork 10, a top tube 20, a down tube 30, a pivot hinge 40, a seat 50 and a supporter 60.

The front fork 10 has a first end and a second end. The first end of the front fork 10 is connected to a handle 11. The second end of the front fork 10 is coupled to a front wheel 12. The down tube 30 has a first end and a second end. The second end of the down tube 30 is coupled to a rear wheel 31. The pivot hinge 40 is connected to the first end of the front fork 10, a second end of the top tube 20 and the first end of the down tube 30. The seat 50 is mounted on a second end of the top tube 20. A first end of the top tube 20 is pivotally connected to the pivot hinge 40. The supporter 60 is connected between the top tube 20 and the down tube 30 respectively, which is configured for supporting the seat 50 on the top tube 20 horizontally from the down tube 30.

The handle 11 comprises a handle bar 110 and a handle post 111. The handle post is installed and lever attached to a steered tube of the front fork 10. The handle bar 110 is connected to the handle post 111.

In one embodiment, the bike of the present invention is an electric bike, and the circuits, wires, batteries and other required for electrically driving components are disposed inside the down tube 30.

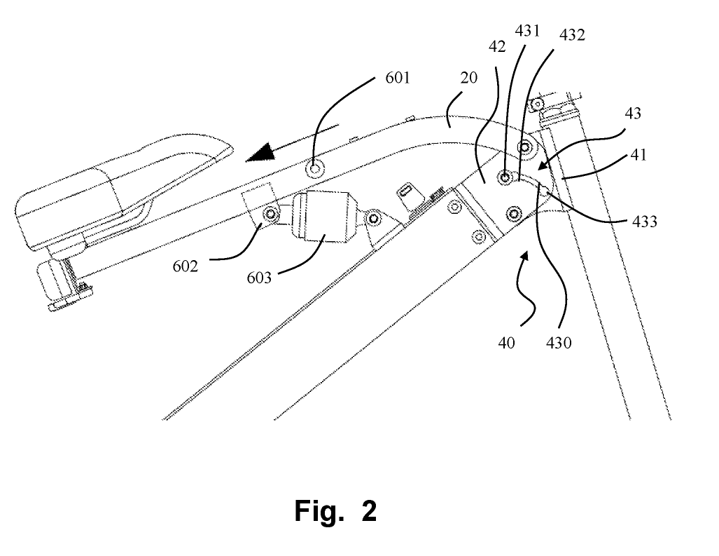

With further reference to FIG. 2, FIG. 2 is an exemplary diagram illustrating the movement of the supporter 60 in accordance with an embodiment of the present invention. The supporter 60 comprises a locking stick 601, a slider 602, and a buffer 603. The slider 602 is inserted inside a track of the top tube 20. The locking stick 601 is penetrated to a side of the top tube 20 to block the movement of the slider 620 inside the track. The buffer 603 is pivotally connected between the slider 602 and the down tube 30.

As shown in FIG. 2, when the locking stick 601 is released, the slider 620 slides along the track toward the second end of the top tube 20. The supporter 60 will not longer to support the seat 50 horizontally, and the top tube 20 move downwardly toward the down tube 30. The buffer 603 will then hide inside the track of the top tube 20.

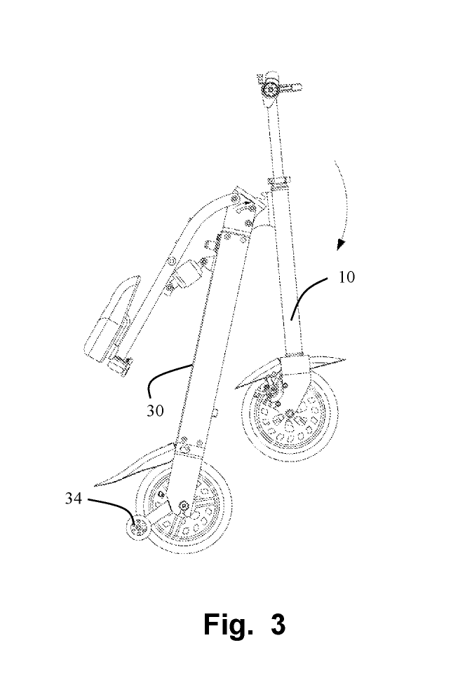

With reference to FIGS. 1 to 3, FIG. 3 is an exemplary diagram illustrating the movement of the front fork 10 moving toward the down tube 30. As shown in FIG. 2, the pivot hinge 40 comprises a first member 41, a second member 42 and a locking assembly 43. The first member 41 is connected to the first end of the front fork 10. The second member 42 is connected to the first end of the down tube 30.

The locking assembly 43 comprises a notch 430 and a locker 431. The notch 430 is formed on the first member 41 and the second member 42, and has a first hole 432 and a second hole 433. The locker 431 penetrates the notch 430, is movable between the first hole 432 and the second hole 433 of the notch 430, and is selectively locked in the first hole 432 and the second hole 433. The locker 431 provides a pivot point that allows the first member 41 and the second member 42 to rotate. The rotation of the first member 41 and the second member 42 will make the front fork 10 fold toward the down tube 30. When the locker 431 is released and is moved from the first hole 432 to the second hole 433, the front fork 10 is able to fold toward the down tube 30.

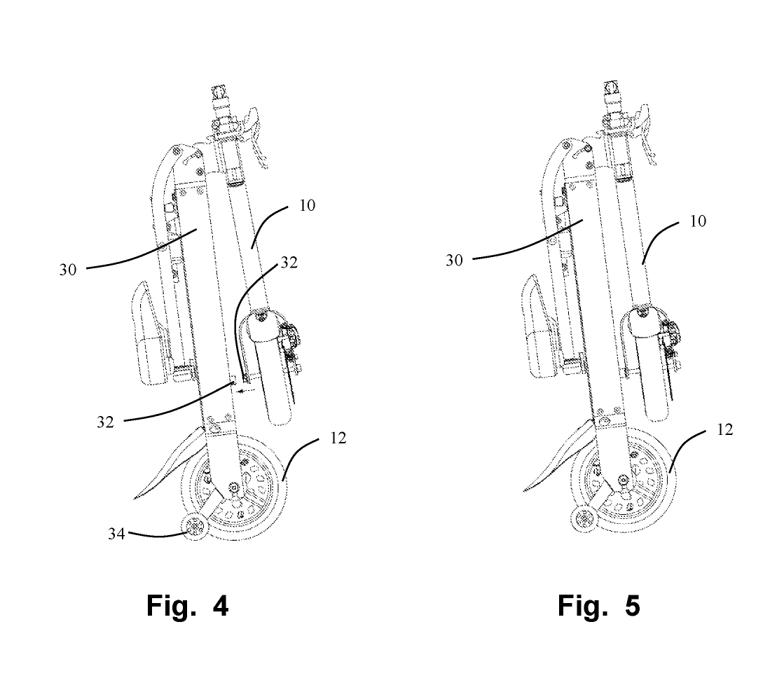

With further reference to FIGS. 4 and 5, FIGS. 4 and 5 are exemplary diagrams illustrating the engagement of the front fork and the wheel folded toward the down tube. As shown in FIG. 4, in this embodiment, the down tube 30 further comprises a concave 32. On a side of the center of the front wheel 12 comprises a protrusion 33. The protrusion 33 may be a nut that is originally adapted for fastening the front wheel 12 and the front fork 10.

When the front fork 10 is folded toward the down tube 30, the steered tube of the front fork 10 turns the front wheel 12 that allows the protrusion 33 being snapped inside the concave 32. Furthermore, the concave 32 may further comprises a magnetic element or itself is made from a magnetic material, which attracts and holds the protrusion 33.

It is noted that like other conventional foldable bikes which the front fork can be folded when is not in the riding operation, without the structure of the concave 32 and the protrusion 33 indicated in the present invention, the front wheel 12 may flip all the time when a person pull the folded bike.

With reference to FIGS. 1-5, the bike of the present invention further comprises a pair of auxiliary wheels 34 mounted on the two sides of the rear wheel 31. As shown in FIG. 1, in an embodiment, The anxiliary wheel 34 is extended backwardly from the center of the rear wheel 31, and is not contact with the ground when the bike is unfolded.

When the front fork 10 and the top tube 20 are folded with the down tube 30, as shown in FIG. 5, the anxiliary wheels 34 are able to provide a standing function with the rear wheel 31 which makes the bike stand on its own.

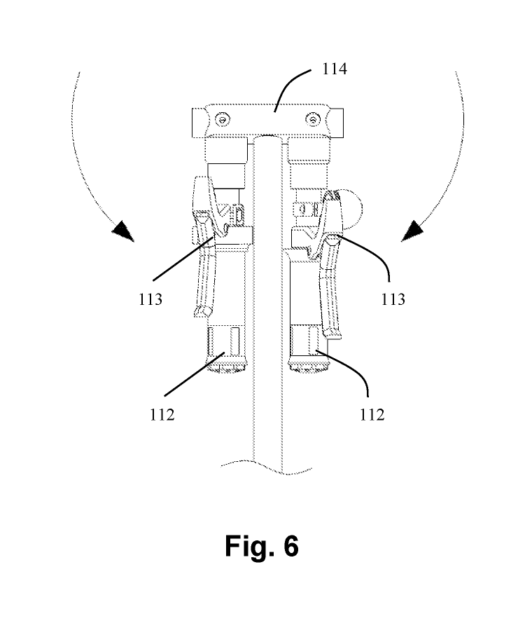

With reference FIG. 6, FIG. 6 is an partially exemplary diagram of illustrating the handle bar in accordance with an embodiment of the present invention. As shown in FIG. 6, the handle bar 110 is consisted of two handlebar grips 112, two front brakes 113 and an adjustable stem 114. Each front brake is mounted on the corresponding handlebar grips 112. The adjustable stem 114 has two ends, and each end of the stem 114 is connected to the corresponding handlebar grips 112 that allows the handlebar grips 112 descended for reducing the volume.

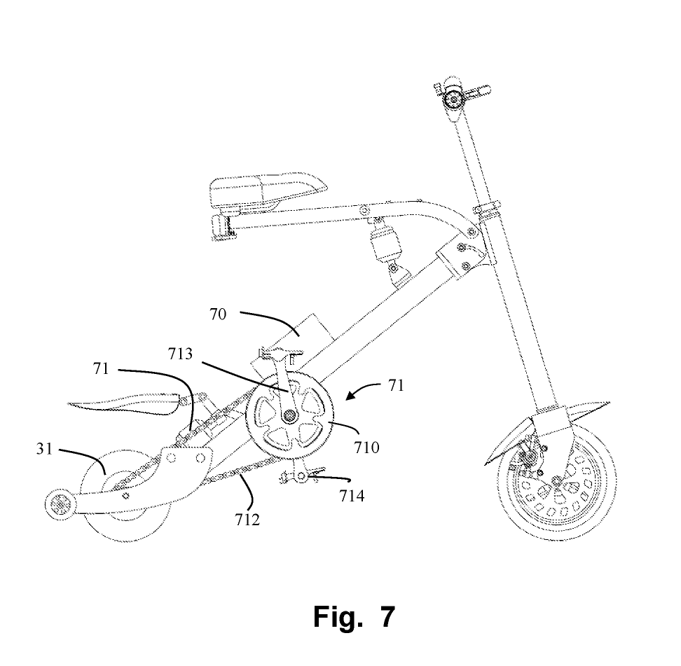

With reference to FIG. 7, FIG. 7 is an exemplary diagram of illustrating a foldable bike in accordance with an embodiment of the present invention. The embodiment of FIG. 7 has made serveal changes compared to the embodiment shown in FIG. 1.

In this embodiment, the battery 70 is located on the down tube 30 which is able for a person to replace new battery easier. The bike further comprises a gear assembly 71 and a second buffer 72. The second buffer 72 is disposed between the rear wheel 31 and the down tube 30.

The gear assembly 71 comprises a first chain ring 710, a second chain ring (not shown), a chain 712. The first chain ring 710 is mounted on a side of down tube 30 underneath the seat 50, and has two crank arms 713 and two pedals 714. The two crank arms 713 are connected to the sides of the first chain ring 710, and each crank arm 713 connects the corresponding pedals 714.

The second chain ring is located with the rear wheel 31. The chain 712 is engaged between the first chain ring 710 and the second chain ring, which transfer power from the pedals 714 to the rear wheel 31 (driven by the second chain ring).

Accordingly, the embodiment of FIG. 7 is the combination of the physical driven bike and electric driven bike.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A bike comprising:
a front fork having a first end and a second end, the first end of the front fork being connected to a handle, and the second end of the front fork being coupled to a front wheel;
a top tube;
a down tube having a first end and a second end, the second end of the down tube being oupled to a rear wheel;
a pivot hinge being connected to the first end of the front fork, a second end of the top tube and the first end of the down tube, wherein the first end of the top tube is pivotally connected to the pivot hinge;
a seat being mounted on a second end of the top tube; and
a supporter being connected between the top tube and the down tube respectively.

2. The bike as claimed in claim 1, wherein the supporter comprises:
a slider being inserted inside a track of the top tube;
a locking stick being penetrated to a side of the top tube to block the movement of the slider inside the track; and
a buffer being pivotally connected between the slider and the down tube.

3. The bike as claimed in claim 2, wherein the slider slides along the track toward the second end of the top tube, and the top tube move downwardly toward the down tube.

4. The bike as claimed in claim 1, wherein the handle comprises a handle bar and a handle post, the handle post is installed and lever attached to a steered tube of the front fork, and the handle bar is connected to the handle post.

5. The bike as claimed in claim 4, wherein the handle bar comprises:
two handlebar grips;
two front brakes, each front brake being mounted on the corresponding handle bar grips; and
an adjustable stem having two ends, and each end of the stem being connected to the corresponding handlebar grips that allows the handlebar grips descended.

6. The bike as claimed in claim 1, further comprising a battery disposed inside the down tube.

7. The bike as claimed in claim 1, wherein the pivot assembly further comprises:
a first member being connected to the first end of the front fork;
a second member being connected to the first end of the down tube; and
a locking assembly having
a notch being formed on the first member and the second member, and having a first hole and a second hole; and
a locker penetrating the notch, being movable between the first hole and the second hole of the notch, and being selectively locked in the first hole and the second hole.

8. The bike as claimed in claim 7, wherein the front fork is fold when the locker is locked in the second hole.

9. The bike as claimed in claim 1, wherein the down tube further comprises a concave and the front wheel comprises a protrusion mounted on a center of the front wheel, which the protrusion is configured for snapping inside the concave.

10. The bike as claimed in claim 9, wherein the concave comprises a magnetic element for attracting and holding the protrusion.

11. The bike as claimed in claim 1, further comprising a pair of auxiliary wheels mounted on the two sides of the rear wheel that are extended backwardly from the center of the rear wheel.

12. The bike as claimed in claim 11, wherein the auxiliary wheels have contact with the ground when the bike is folded and make the bike standing on the ground.

13. The bike as claimed in claim 1, wherein a battery is located on the down tube.

14. The bike as claimed in claim 1, further comprising a second buffer disposed between the rear wheel and the down tube.

15. The bike as claimed in claim 1, further comprising:
a gear assembly comprising
a first chain ring being mounted on a side of down tube underneath the seat, and having two pedals; and
two crank arms being connected to the sides of the first chain ring, and each crank arm connecting the corresponding pedals;
a second chain ring being located with the rear wheel; and
a chain is engaged between the first chain ring and the second chain ring.
